(19) United States
(12) Patent Application Publication
(10) Pub. No.: US 2005/0023303 A1
(43) Pub. Date: Feb. 3, 2005

(54) Metering tap

(76) Inventors: Lawrence John Sant, Gladstone (AU); Susanne Elizabeth Sant, Gladstone (AU); Jeffery Leeke, Gladstone (AU); Berneice Margaret Leeke, Gladstone (AU)

Correspondence Address: KATTEN MUCHIN ZAVIS ROSENMAN, 575 MADISON AVENUE, NEW YORK, NY, 10022-2585, US

(21) Appl. No.: 10/933,767

(22) Filed: Sep. 3, 2004

(30) Foreign Application Priority Data
Mar. 4, 2002 (AU) PS0883

(51) Int. Cl. G01F 11/28

(52) U.S. Cl. 222/452

(57) ABSTRACT

A metering tap comprising a housing and a rotatable valve disposed within said housing, said housing having an inlet and an outlet, the housing and the rotatable valve forming a chamber of a preselected volume wherein in a priming condition the rotatable valve is oriented whereby the inlet is open and the outlet is closed, wherein in an intermediate condition the rotatable valve is oriented whereby the inlet is closed and the outlet is closed, and wherein in a dispensing condition the rotatable valve is oriented whereby the inlet is closed and the outlet is open.

The present invention relates to a tap for dispensing a liquid from a reservoir. In particular the present invention relates to a tap for dispensing a metered quantity of liquid from a reservoir.

A wide variety of liquids are dispensed from reservoirs. Often the liquids being dispensed are required in prescribed quantities. Various measures may be used. Generally, a conventional tap is used to dispense liquid into a measuring cup. However, there have been proposed a number of dispensing devices that measure the quantity of liquid prior to dispensing the required quantity. Generally such devices are of complex construction and expensive to manufacture and not suitable for widespread use across a variety of applications.

We have now found a simple yet effective means for dispensing a preselected volume of liquid. According to the present invention there is provided a metering tap comprising a housing and a rotatable valve disposed within said housing, said housing having an inlet and an outlet, the housing and the rotatable valve forming a chamber of a preselected volume wherein in a priming condition the rotatable valve is oriented whereby the inlet is open and the outlet is closed, wherein in an intermediate condition the rotatable valve is oriented whereby the inlet is closed and the outlet is closed, and wherein in a dispensing condition the rotatable valve is oriented whereby the inlet is closed and the outlet is open.

The metering tap of the present invention may be used for dispensing fluid supplied from any convenient source. For example the metering tap may be disposed on the end of a pipe or hose and be connected to a continuously flowing source. A continuous source may be a similar to a mains water supply.

In a preferred form of the present invention the metering tap is mounted on a container filled with a fluid to be dispensed in metered doses. The metering tap may be fixedly mounted on the container or removably mounted on the container. The metering tap may be mounted directly on the container, such as by engaging with an aperture in the container. The metering tap may snap fit into the aperture or may screw into the aperture with a screw thread. It will be apparent to those skilled in the art that other forms of mounting may be applicable. Alternatively an adapter may be mounted into the aperture and the metering tap engaged with the adapter. The metering tap may be rotatably engaged with the adapter such that the metering tap can dispense the fluid through a nozzle that is fixed to the housing.

The housing may be of any convenient shape that may be selected based upon ergonomic and/or aesthetic considerations. The housing is configured to have the rotatable valve disposed therein for rotation. In one form, the housing may have a cylindrical bore extending therein, into which bore the rotatable valve may be inserted. The rotatable valve may have the chamber formed within the rotatable valve. Alternatively, the rotatable valve cooperates with the housing to form the chamber. In another form the housing may form the chamber and the rotatable valve simply function as a valve for opening and closing the inlet and outlet respectively.

The housing has an inlet for allowing a fluid to fill the chamber. The inlet may include a connector that extends through the housing for fluid communication between the fluid source and the chamber. The connector preferably engages the fluid source in a removable fashion although a permanent fixture falls within the ambit of the present invention. The housing may preferably be snap-fitted or screwed to the fluid source. Whilst it is preferred that the inlet is located on the outside of the container and include connection therewith, the inlet, and optionally for the remote end of the rotatable valve may extend into the container.

The housing may have a bore that receives the rotatable valve. The bore or may be an open bore or a closed bore. In the embodiment in which the housing includes a closed bore the rotatable valve may be open adjacent the base of the bore, with the bore closing the chamber. In an alternative embodiment the bore may be an open bore extending through the housing. The remote end of the bore may be fully or partially open. It is advantageous that the remote end of the bore be partially open and the rotatable valve includes a retention stop that limits its rotation. Suitably placed retention stops allow the rotatable valve to be aligned with the inlet and outlet in the housing for filling and dispensing from the metering tap.

The rotatable valve may of suitable configuration based on the type of housing employed. For example, where the housing forms the chamber the rotatable valve simply needs to operate as a valve on both the inlet and the outlet. In a preferred form of the present invention the rotatable valve cooperates with the housing to form the chamber. The rotatable valve itself may also form the chamber within its form whereby the chamber is brought into fluid communication with the inlet and the outlet respectively in the various conditions of the metering tap.

In a preferred form the rotatable valve includes a chamber. The chamber may have apertures that align with the inlet and outlet in the housing respectively. In a filling condition an aperture within the chamber aligned with the inlet and upon rotation of the rotatable valve the same or another aperture aligned with the outlet to dispense with a metered quantity of fluid.

The inlet may simply be an aperture in the housing in fluid communication with the source of the fluid. The inlet may be of more complex construction. The inlet may include a clear viewing portion that allows the user to observe the flow of fluid into the metering tap.

The outlet may simply be an aperture in the housing or preferably may include a spout or nozzle whereby the flow of fluid from the chamber may be readily directed and controlled.

An air bleed may be associated with the outlet whereby air is allowed into the chamber whilst the outlet is open such that the dispensing of fluid from the chamber is facilitated. Preferably the air bleed is disposed in the top of the chamber whereas the outlet is disposed in the bottom of the chamber.

An airlock may be formed in the chamber. In order to remove the airlock an air bleed may be provided as described above. It is preferred that the fill opening in the rotatable valve is located at the top of the chamber so that no air remains trapped in the filled chamber. It is preferred that the chamber is located below the inlet, although it is acceptable for the top of the chamber to be located at the same level as of the inlet. In one preferred form the chamber may be of irregular shape such that it is maintained in a filling condition below the inlet.

The housing and the rotatable valve may form a chamber. Whilst in the preferred form of the invention the housing cooperates with the rotating valve to form the chamber, the present invention also embraces a chamber formed substantially by either the housing or the rotatable valve. Such configurations may simply employ the other component to seal the inlet or the outlet in the various conditions. In the preferred embodiment, a closed bore in the housing cooperating with a cup-shaped rotating valve forms the chamber. In this preferred configuration the end of the closed bore includes the inlet and the rotating valve includes an extension that operates to open and close the inlet. Cooperating apertures in the bottom of the housing and the rotating valve respectively form the outlet.

The chamber may be of fixed volume determined in the manufacture of the metering tap. In one form the chamber may be of variable volume such as by employing a telescoping, rotating valve cooperating with the housing.

The telescoping, rotating valve may be in the form of opposed cup sections that are slideably engaged with each other, the chamber being formed by the cavity within the opposed cup sections. In an alternative embodiment, the telescoping, rotating valve may be in the form of an outer sleeve having a plunger disposed with said sleeve. The plunger may have a rubber seal that defines the end of the chamber remote from the inlet. A telescoping, rotating valve of this type may be in a form similar to that of a syringe.

In another form, for the volume of the chamber may be controlled by forming the rotatable valve with an open ended cylinder having a handle at one end and into which he is located a stop at the other. These stop may be of a shape chosen to extend into the chamber and limit its volume. A variety of stops may be provided so that the user may vary the volume of the chamber to suit the particular application. Alternatively, a fixed and all may be provided to the chamber and a removable handle may extend into the chamber and control its volume.

The housing and the rotating valve may engage each other by via a peripheral seal disposed on the inside of the housing. The use of a seal may not be required if the respective components may be manufactured to required tolerances. Suitable seals may be in the form of a rubberised washer or an o-ring.

The chamber, whether formed within the rotatable valve, or otherwise, may be oriented horizontally, vertically or inclined to the vertical. The chamber may radiate outwardly from the container or may be aligned longitudinally with the perimeter of the container. The chamber may be aligned in any other convenient manner.

In the priming condition the metering tap allows the chamber to be filled with fluid. The inlet in open to the source of fluid and the outlet is closed.

In the dispensing condition the metering tap allows fluid filling the chamber to be dispensed. The inlet is closed to the source of fluid and the outlet is open such that fluid disposed within the chamber is dispensed.

In the intermediate condition both the inlet and outlet are closed. As the rotatable valve is rotated from the priming condition to the dispensing condition the intermediate condition prevents the unregulated dispensing of fluid. It may be desirable to leave the metering tap in the intermediate condition after the fluid has been dispensed from the chamber during storage so that fluid is not left in the chamber during storage.

In a preferred embodiment of the present invention the rotatable valve may be rotatable to an open condition wherein both the inlet and the outlet are open. In this condition the metering tap functions as a simple valve allowing the continuous discharge of fluid.

The rotating valve rotates in the housing between various positions that correspond to the various conditions including the priming condition, the intermediate condition and the dispensing condition as well as optionally an open condition. Stops may be provided to assist the user in locating the various operative conditions of the metering tap. The stops may be in the form of end stops that prevent the rotating valve from being rotated past desired conditions.

In a basic form of the invention the rotating valve has three positions corresponding to the priming condition, the intermediate condition and the dispensing condition. End stops may be provided to prevent the rotating valve being rotated past the priming condition and the dispensing condition respectively. The intermediate condition may be located with a stop or may simply be the continuum between the priming condition and the dispensing condition. Alternatively the intermediate condition may be located with a stop. A suitable stop for the rotating valve that assists the user identify a position associated with a desired condition may be in the form of a projection disposed on the periphery of the rotating valve associated with a notch on the housing. Alternatively the notch may be disposed on the rotating valve and the projection disposed on the housing. Suitable projections include rounded projections that may be readily engaged and disengaged with their associated notches.

The metering tap of the present invention may also include a variety of additional components as may be selected by persons skilled in the field.

The present invention will now be described with reference to the accompanying drawings. It will be understood that the accompanying drawings are provided for illustrative purposes and are not intended to limit the scope of the present invention.

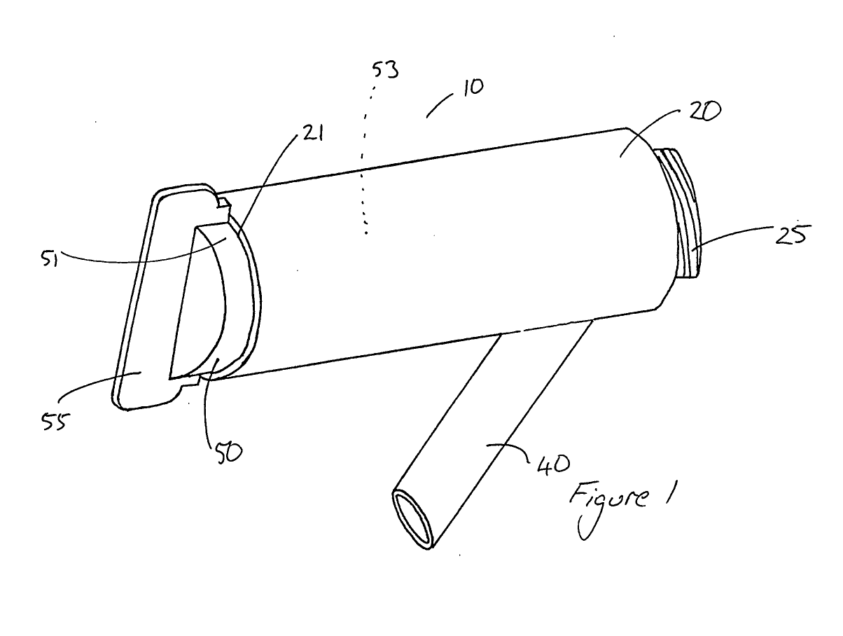

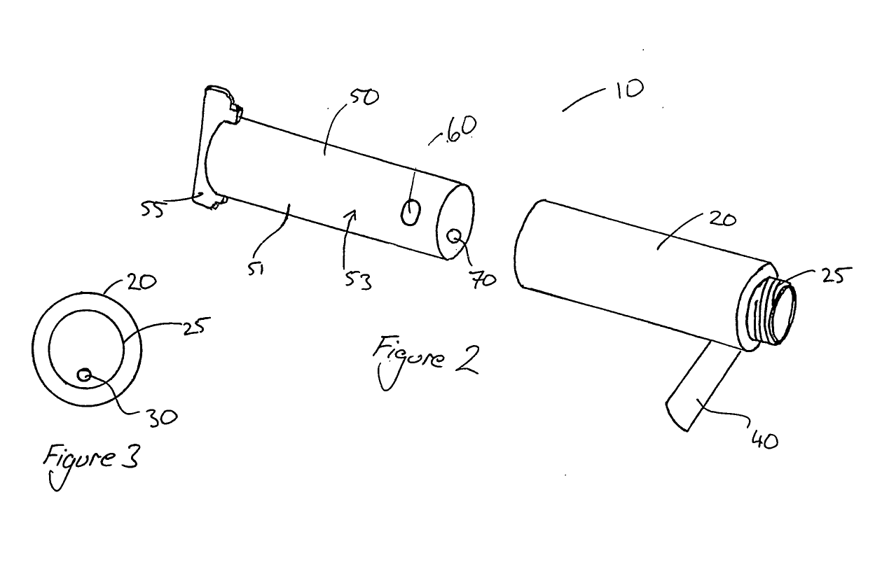

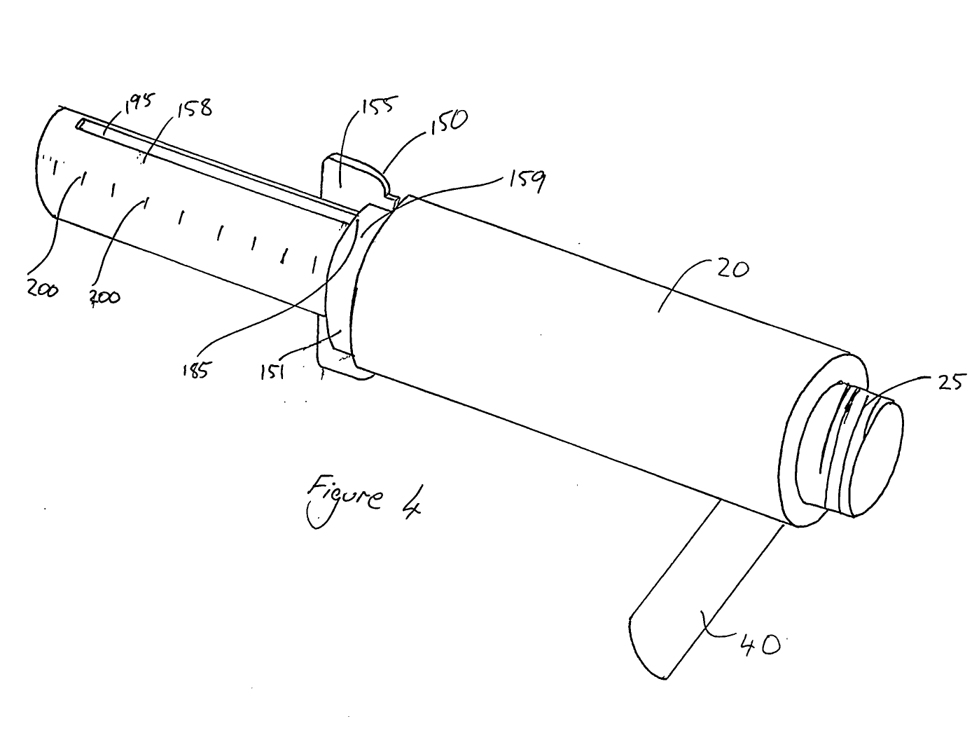

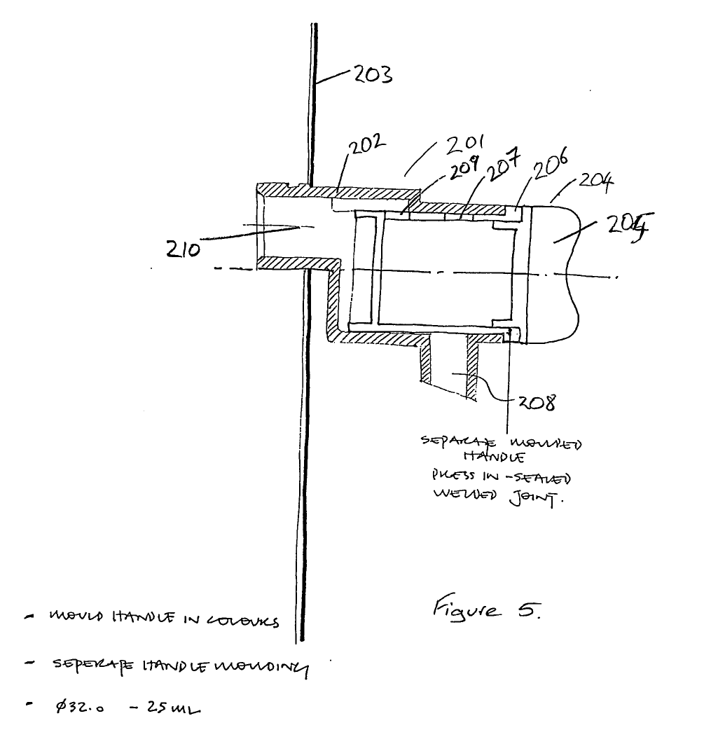

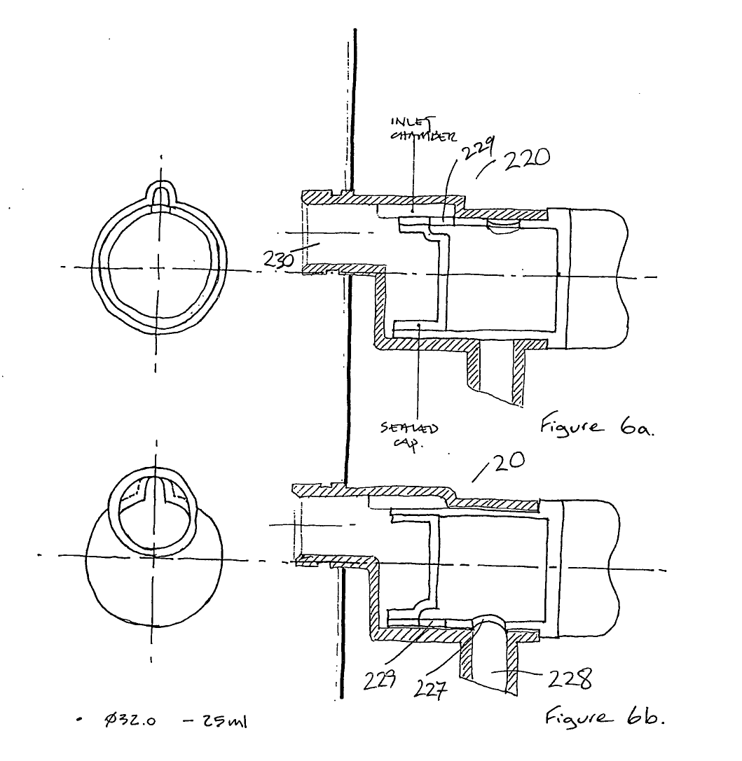

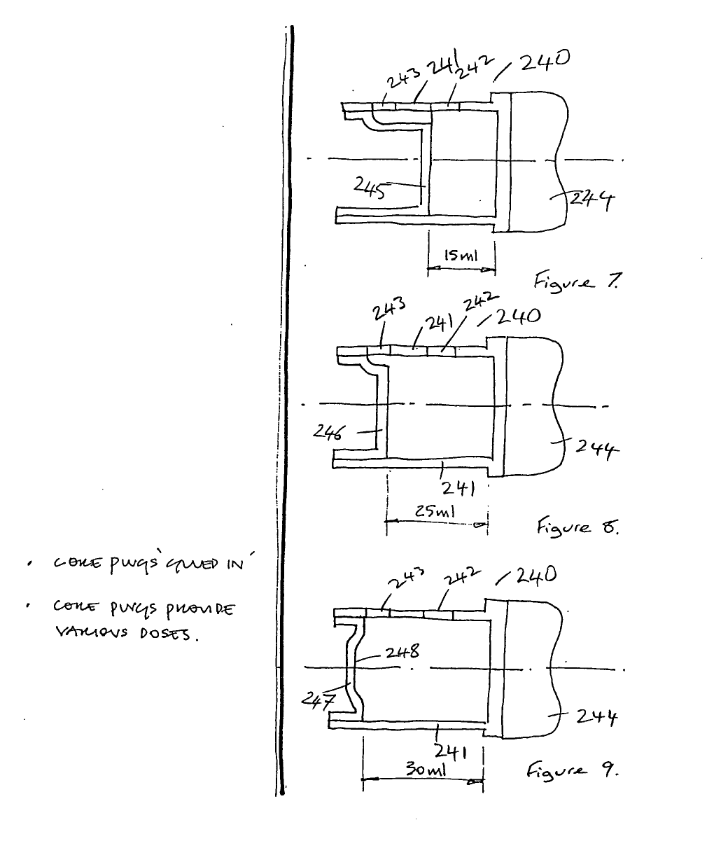

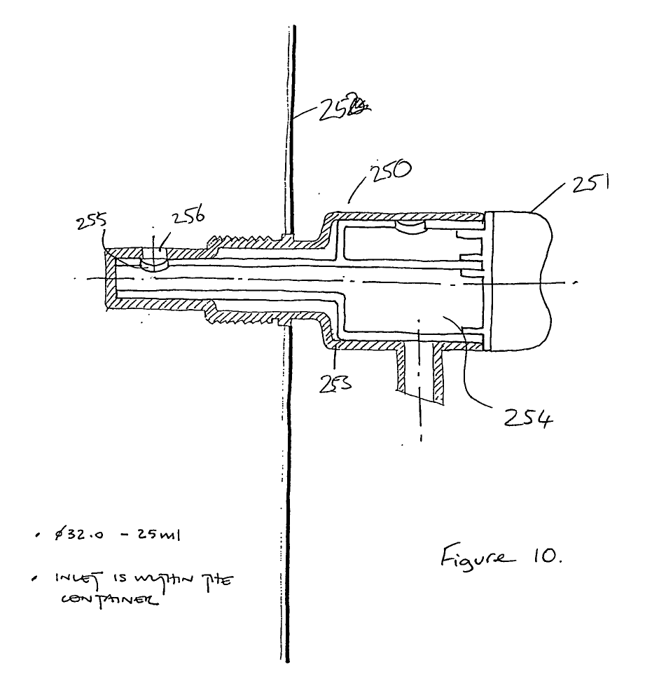

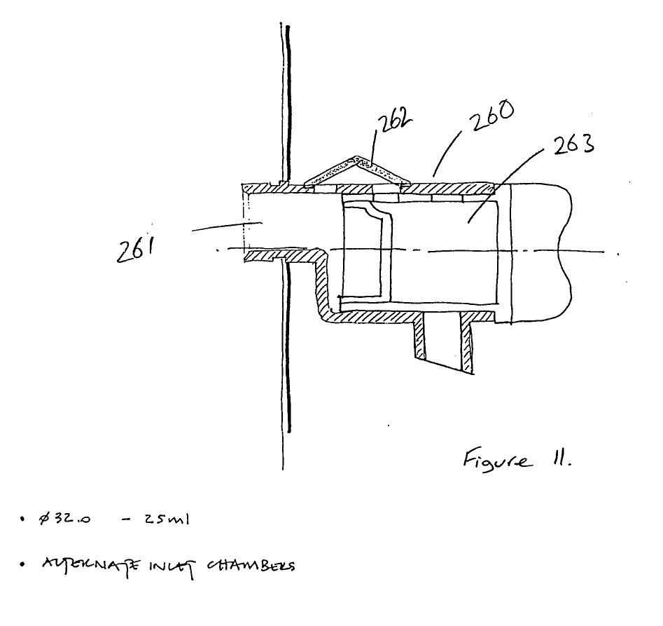

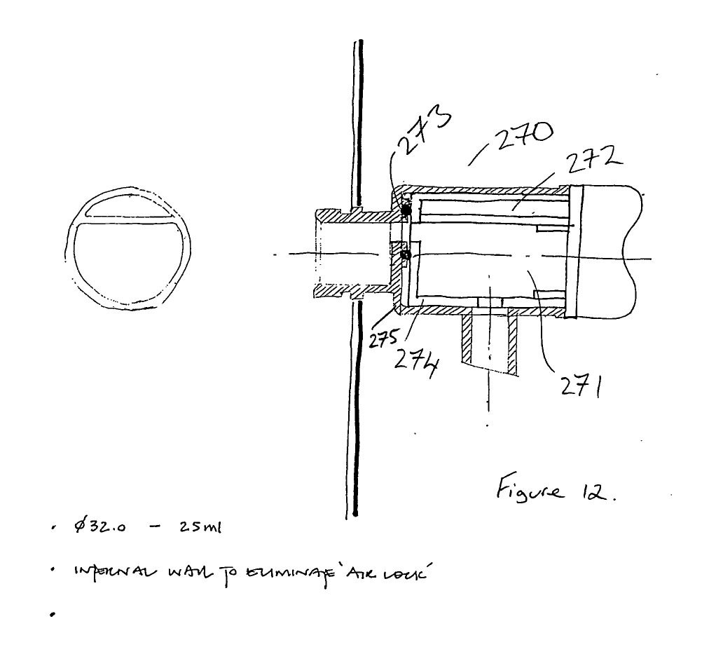

FIG. 1 shows a plan view of a metering tap according to one embodiment of the present invention.

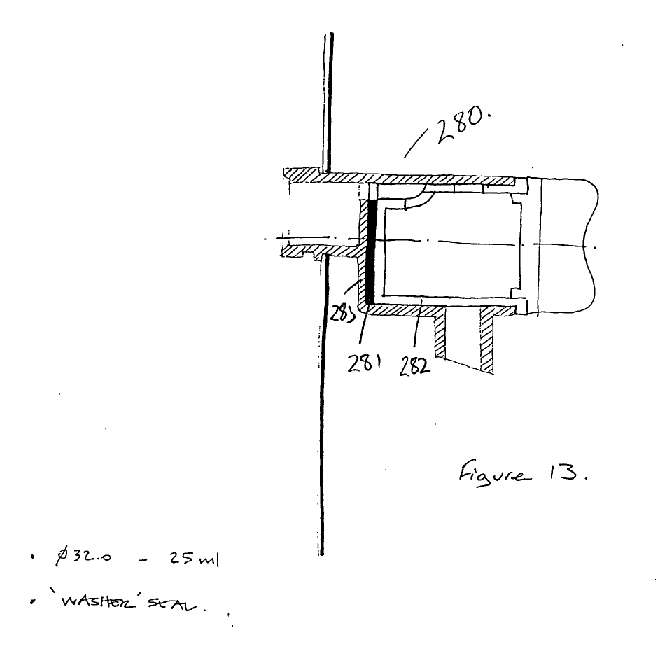

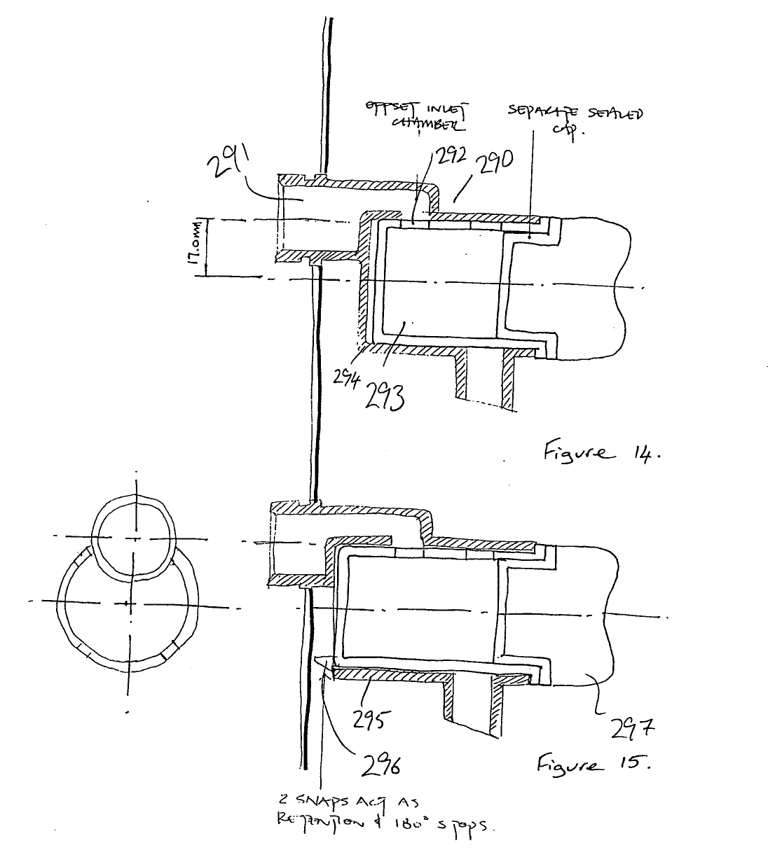

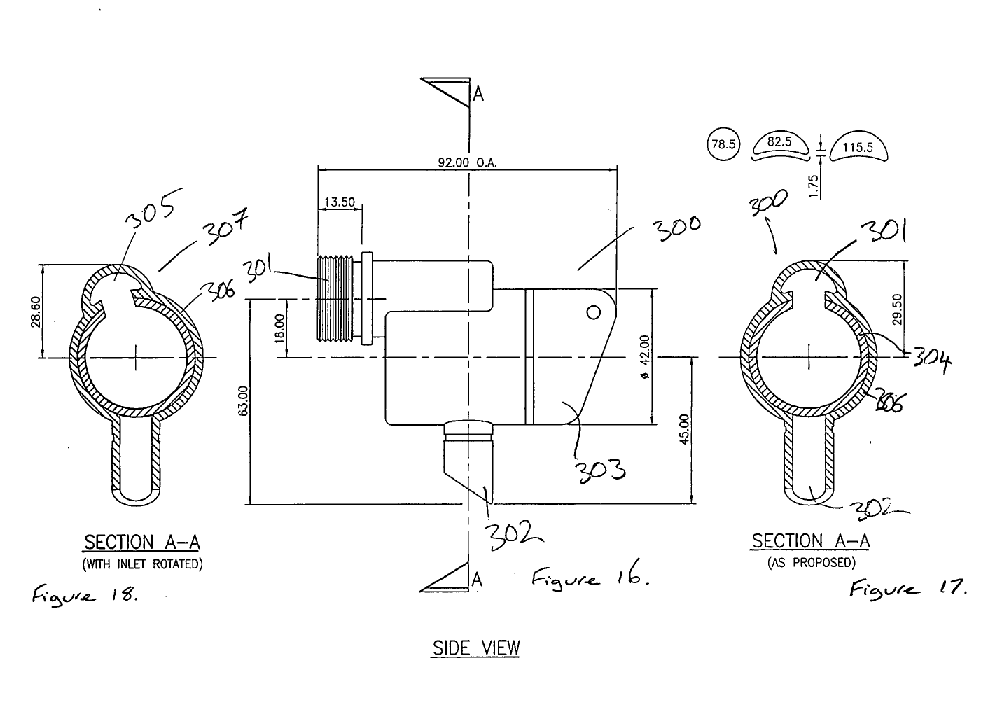

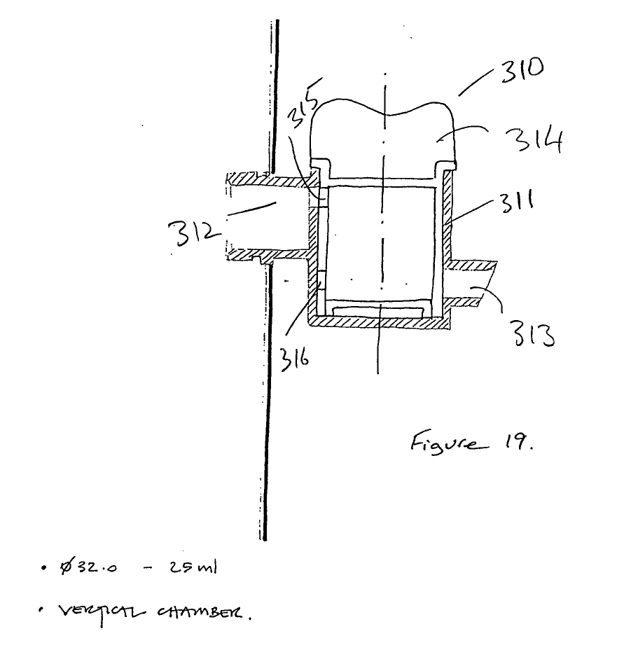

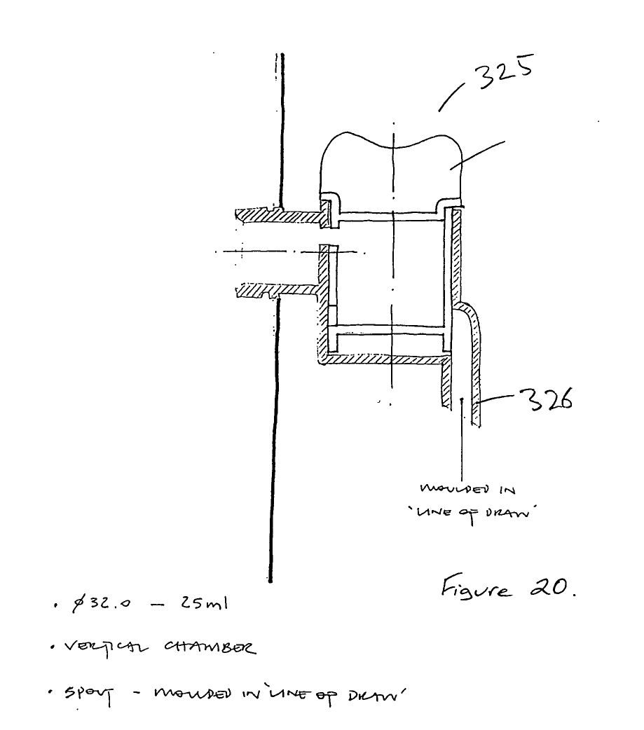

FIG. 2 shows an exploded plan view of the metering tap shown in FIG. 1.

FIG. 3 shows an end view of the housing of the metering tap shown n FIG. 1.

FIG. 4 shows a plan view of a telescoping, rotating valve that may be inserted into the housing shown in FIGS. 1 to 3.

FIG. 5 shows a side cross-sectional view of a metering tap according to another embodiment of the invention.

FIG. 6a shows a side cross-sectional view of a metering tap according to another embodiment of the invention.

FIG. 6b shows a side cross-sectional view of the metering tap shown in FIG. 6a where the rotatable valve is rotated to a dispensing condition.

FIG. 7 shows a side cross-sectional view of a metering tap according to another embodiment of the invention.

FIG. 8 shows a side cross-sectional view of the metering tap of FIG. 7 with a different sized ended stop.

FIG. 9 shows a side cross-sectional view of the metering tap of FIG. 7 with a different sized and stop.

FIG. 10 shows a side cross-sectional view of a metering tap of another embodiment of the present invention with the rotatable valve extending into the container.

FIG. 11 shows a side cross-sectional view of a metering tap of another embodiment of the invention.

FIG. 12 shows a side cross-sectional view of a metering tap of another embodiment of the invention.

FIG. 13 shows a side cross-sectional view of a metering tap of another embodiment of the invention.

FIG. 14 shows a side cross-sectional view of a metering tap of another embodiment of the invention.

FIG. 15 shows a side cross-sectional view of a modified metering tap according to FIG. 14.

FIG. 16 shows a side view of a metering tap according to the invention.

FIG. 17 shows a longitudinal cross-sectional view of the metering tap shown in FIG. 16.

FIG. 18 shows a longitudinal cross-sectional view of a modified metering tap according to FIG. 16.

FIG. 19 shows a side cross-sectional view of a metering tap of another embodiment of the invention.

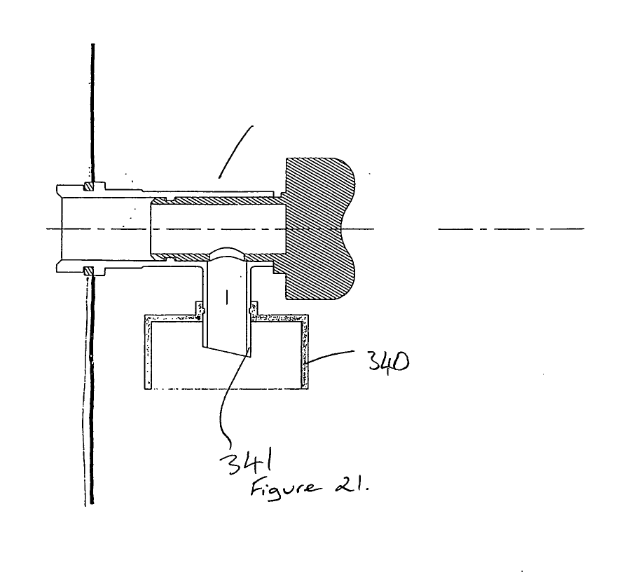

FIG. 20 shows a side cross-sectional view of a metering tap of another embodiment of the invention.

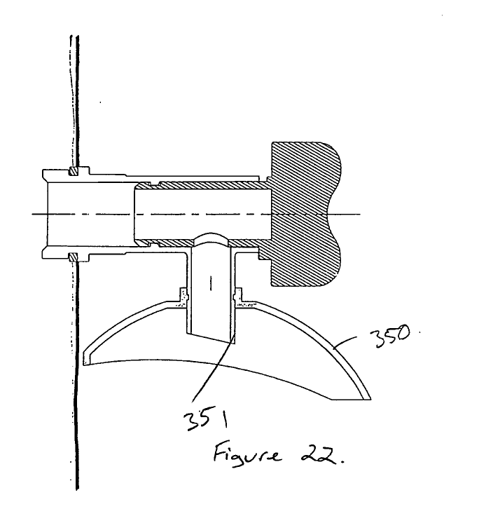

FIG. 21 shows a side cross-sectional view of a metering tap according to the invention having a shroud over the outlet.

FIG. 22 shows a side cross-sectional view of a metering tap according to the invention having a modified shroud over the outlet.

In FIGS. 1 and 2 there is shown a metering tap 10 that may be screwed into a container (not shown) for dispensing fluid from the container in metered quantities. The metering tap 10 includes a housing 20 and a rotating valve 50. The housing 20 has a screw fitting 25 that may be screwed into a corresponding threaded aperture in the container (not shown). The housing 20 has a cylindrical bore 21 into which the rotating valve 50 is rotatably engaged. A nozzle 40 is disposed on the underside of the housing 20.

The rotatable valve 50 has a lever 55 that allows an operator to rotate the rotatable valve 50. The rotatable valve 50 is substantially hollow whereby the cavity therein forms the metering chamber 53. The outer wall 51 of the rotating valve 50 is closely seated in the cylindrical bore 21 to prevent leakage of fluid therefrom. In the outer wall 51 there is a first orifice 60 that with the rotating valve 50 oriented to a dispensing condition is aligned with the nozzle 40. In the intermediate condition and the priming condition the first orifice 60 is disposed in abutment with the internal surface 22 of the cylindrical bore 21 such that fluid within the chamber 53 is retained therein.

A second orifice 70 is disposed on the end wall 52 of the rotating valve 50. In the priming condition the second orifice 70 is aligned with an inlet 30 (shown in FIG. 3). In the intermediate condition and the dispensing condition the second orifice 70 is disposed in abutment with the internal surface of the blind end 23 cylindrical bore 21 such that fluid cannot enter the chamber 53 from the container (not shown).

FIG. 4 shows a telescoping rotating valve 150 formed from a first slidable portion 158 and a second slidable portion 159. The first slidable portion 158 is slidable within the second slidable portion 159. The second slidable portion 159 has a lever 155 that allows an operator to rotate the telescoping rotatable valve 150. The telescoping rotatable valve 150 is substantially hollow whereby the cavity therein forms the metering chamber 153.

The outer wall 151 of the second slidable portion 159 is closely seated in the cylindrical bore 21 to prevent leakage of fluid therefrom. In the outer wall 151 there is a first orifice 160 that with the rotating valve 150 oriented to a dispensing condition is aligned with the nozzle 40. In the intermediate condition and the priming condition the first orifice 160 is disposed in abutment with the internal surface 22 of the cylindrical bore 21 such that fluid within the chamber 153 is retained therein.

A second orifice 170 is disposed on the end wall 152 of the second slidable portion 159. In the priming condition the second orifice 170 is aligned with an inlet 30 (shown in FIG. 3). In the intermediate condition and the dispensing condition the second orifice 170 is disposed in abutment with the internal surface of the blind end 23 cylindrical bore 21 such that fluid cannot enter the chamber 153 from the container (not shown).

The inner wall 180 of the second slidable portion 159 has a projection 185 that engages with a guide channel 195 in the outer wall 190 of the first slidable portion 158. The guide channel 195 extends longitudinally along the first slidable portion 158 although to allow a finer control of the volume of chamber 153 a channel 195 that is disposed in a spiral around the outer wall 190 may be used. Graduations 200 are provided on the outer wall 190 that when aligned with the housing 20 permit the volume of the chamber 153 to be controlled.

FIG. 5 shows a metering tap 201 formed of a housing 202 there is engaged with these side or of a container 203. A rotatable valve 204 includes a handle 205. The handle 205 is press sealed with a sleeve 206. The sleeve 206 includes an opening 207 that aligns with outlet 208 in the dispensing condition (not shown). Opening 209 is aligned with the inlet 210 such that fluid can pass into the sleeve 206 in the priming condition shown.

FIGS. 6a and 6b show a metering tap to 20 into the priming and dispensing conditions is respectively. In FIG. 6a opening 229 is aligned with the inlet 230. In that the dispensing condition shown in FIG. 6b a opening 227 is aligned with the outlet 228.

FIGS. 7 8 and 9 show a rotatable valve 240. The rotatable valve 240 includes a cylindrical sleeve 241 in which apertures 242 and 243 are disposed. The sleeve 241 includes a handle 244. The remote end of the sleeve his sealed where the end stops 245 246 and 247 respectively. End stops 245 extends into the sleeve 241 to provide an internal volume of 15 ml. End stops 246 extends less into the sleeve and provides an internal volume of 25 ml. End stops 247 includes a concave surface 248 that allows the internal volume of the sleeve 241 to be 30 ml.

FIG. 10 shows a metering tap 250 having a rotatable valve 251 that extends into the container 252. The metering tap 250 has a housing 253 that screws into the container 252. The rotatable valve 251 forms a chamber 254 that has an opening 255 that is aligned with an inlet 256 into the housing 253.

FIG. 11 shows a metering tap 260 having a convoluted inlet 261. The convoluted inlet 261 includes a transparent window 262 that allows the user to observe fluid flying into chamber 263.

FIG. 12 shows a metering tap 270 having an internal portion 272 of chamber 271 blocked such that the internal portion to 72 does not form a trap for retaining air within the chamber 271 into the priming condition. An O-ring 273 provides a seal between the sleeve 274 and the housing 275.

FIG. 13 shows a metering tap 280 and includes a washer 281 disposed between the sleeve 282 and the housing 283.

FIG. 14 shows a convoluted inlet 291 in a metering tap 290. The convoluted inlet 291 is aligned with an opening 292 in the top of the chamber 293 in the priming condition. The end of the housing 294 years closed. FIG. 15 shows a housing 295 having an open portion that can engage a retention stopped 296 that limits of the rotation of the rotatable bar of 297.

FIGS. 16 and 17 show a metering tap 300 with an inlet 301 aligned above the outlet 302. Rotation of the rotatable valve 303 causes and opening in the sleeve 304 to align respectively with the convoluted inlet 301 and the outlet 302. FIG. 18 shows the convoluted inlet 305 located around the housing 306 so as to reduce the overall height of the metering tap 307 compared to the metering tap 300.

FIG. 19 shows a vertically oriented metering tap 310. The housing 311 includes an inlet 312 and an outlet 313. A rotatable valve 314 includes openings 315 and 316 that aligned with the inlet 312 and the outlet 313 respectively. FIG. 20 shows a variation on the metering tap 310 shown in FIG. 19. The metering tap 325 shown in FIG. 20 includes an outlet 326 that is vertically oriented.

The FIG. 21 shows a shroud 340 mounted over the outlet 341. FIG. 20 to shows a shroud 350 mounted over outlet 351.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A metering tap for dispensing a preselected volume of fluid from a container, wherein the metering tap comprises a housing and a rotatable valve disposed within said housing, said housing having an inlet opening into said container and an outlet, the housing and the rotatable valve forming a chamber of a preselected volume wherein in a priming condition the rotatable valve is oriented whereby the inlet is open and the outlet is closed whereby fluid from the container fills the chamber, wherein in an intermediate condition the rotatable valve is oriented whereby the inlet is closed and the outlet is closed and the preselected volume of fluid is retained in said chamber, and wherein in a dispensing condition the rotatable valve is oriented whereby the inlet is closed and the outlet is open whereby the preselected volume of fluid is dispensed from said chamber.

2. A metering tap according to claim 1 wherein the metering tap further includes an air bleed associated with the outlet whereby said air bleed is open whilst the outlet is open.

3. A metering tap according to claim 2 wherein the air blled comprises an aperture in the top of the chamber when the chamber is in the dispensing condition.

4. A metering tap according to claim 1 wherein the chamber is formed in the rotatable valve.

5. A metering tap according to claim 1 wherein the rotatable valve cooperates with the housing to form the chamber.

6. A metering tap according to claim 1 wherein the chamber is formed in the housing and the rotatable valve functions as a valve for opening and closing the inlet and outlet respectively.

7. A metering tap according to claim 1 wherein the housing includes a cylindrical bore into which bore the rotatable valve is inserted.

8. A metering tap according to claim 1 wherein the inlet includes a connector that extends through the housing for fluid communication between a fluid source and the chamber.

9. A metering tap according to claim 1 wherein the housing includes a closed bore.

10. A metering tap according to claim 9 wherein the rotatable valve is open adjacent the base of the bore, with the bore closing the chamber.

11. A metering tap according to claim 1 wherein the housing includes an open bore.

12. A metering tap according to claim 7 wherein the bore is partially open and the rotatable valve includes a retention stop that limits its rotation.

13 A metering tap according to claim 1 wherein the chamber includes at least one aperture that align with the inlet and outlet in the housing respectively whereby in a filling condition an aperture is aligned with the inlet and upon rotation of the rotatable valve the same or another aperture is aligned with the outlet.

14. A metering tap substantially as herein above described with reference to the drawings.
